(19) United States
(12) Patent Application Publication
(10) Pub. No.: US 2017/0327000 A1
(43) Pub. Date: Nov. 16, 2017

(54) ELECTRIC VEHICLE

(71) Applicant: Sharp Kabushiki Kaisha, Sakai City, Osaka (JP)

(72) Inventors: Takasumi WADA, Sakai City (JP); Tetsushi ITO, Sakai City (JP)

(21) Appl. No.: 15/521,944

(22) PCT Filed: Sep. 2, 2015
(86) PCT No.: PCT/JP2015/074932

§ 371 Date: Apr. 26, 2017

(30) Foreign Application Priority Data
Nov. 7, 2014 (JP) 2014-226603

(51) Int. Cl. B60L 11/18; B60L 15/00; B60L 15/20

(52) U.S. Cl. CPC B60L 11/1877; B60L 15/2054; B60L 15/007; B60Y 2200/10; B60L 2220/42

(57) ABSTRACT

An electric vehicle (1) includes, a chassis (10), a pair of front (21, 31) and rear wheels (22, 32) provided on a right side of the chassis (10) and a pair of front (21, 31) and rear wheels (22, 32) provided on a left side of the chassis (10), two motors (41R, 41L) that drive any of the right and left front wheels (21, 31) or the right and left rear wheels (22, 32), a sprocket (21b, 22b, 31b, 32b) and a belt (23, 33) serving as a power transmission member transmitting power between the front and rear wheels of each pair, and a battery (40) that supplies power to the electric motors (41R, 41L). Changing of a direction or turning of the electric vehicle (1) is performed by changing the rotational speed or a rotation direction by gearboxes (43R, 43L) for the power from the electric motors (41R, 41L).

### TECHNICAL FIELD

The present invention relates to an electric vehicle, and specifically relates to an electric vehicle suitable for autonomous travel and that has a battery and uses an electric motor as a power source.

### BACKGROUND ART

There are vehicles configured to travel by using alternative fuel such as electricity, hydrogen fuel, and biofuels in addition to petroleum fuel. In a case where electricity, hydrogen, or the like is used, even though the continuous travel distance is less than in a case where petroleum fuel is used, carbon dioxide emission may be eliminated during traveling, and the range of applications increases, and in a case of a battery-driven vehicle, it is possible to easily achieve miniaturization of the vehicle compared with a case of using hydrogen or the like. Thus, the demand for battery-driven electric vehicles has been increasing for various applications such as a transportation vehicle, a care vehicle, and a monitoring vehicle.

Although a steering mechanism which changes the angles of the front and rear wheels to change the direction of a vehicle may also be used, a complex steering mechanism is required, and an increase in the size of the vehicle is unavoidable, such that such a steering mechanism is not suitable for an autonomous guided vehicle that may be required to turn in narrow places. On the other hand, a skid-steer mechanism by which right and left wheels rotate in opposite directions relative to each other is known as a mechanism that enables turning, even on the spot. For example, PTL 1 describes a method of turning a vehicle by individually driving right and left drive wheels with a pair of electric motors. In a case where there are four wheels, as disclosed in PTLs 2 and 3, for example, a technique of driving left-side front and rear wheels and right-side front and rear wheels independently has been considered.

### CITATION LIST

### Patent Literature

PTL 1: Japanese Unexamined Patent Application Publication No. 2003-70849

PTL 2: Japanese Unexamined Patent Application Publication No. 55-78729

PTL 3: Japanese Unexamined Patent Application

Publication No. 2011-84223

### SUMMARY OF INVENTION

### Technical Problem

A vehicle disclosed in PTL 1 has only a pair of right and left drive wheels as drive wheels, and hence it is difficult to apply the vehicle to a four-wheel drive vehicle of the same size. A battery-driven electric vehicle needs a space for where a motor for driving a wheel is to be placed, a space for where a gearbox arranged between an electric motor and a front wheel or between an electric motor and a rear wheel is to be placed, and further a space for where a battery is to be placed. However, neither PTL 1 nor PTL 3 above discloses specific arrangement of an electric motor or a method of mounting a battery. In a vehicle described in PTL 2, two hydraulic pumps are driven by using one engine as a drive source, and right and left drive wheels are driven by hydraulic motors, such that no electric motor is used.

With a mechanism by which, while adopting a skid-steer mechanism, driving is performed with one electric motor via a gearbox such that there is a difference between the rotational speeds of right and left wheels, the gearbox itself unavoidably has a complex structure and an increased size, and it is difficult to miniaturize such a vehicle. When performing driving by providing an electric motor for each of the four wheels, it is difficult to control rotation of the electric motors, and large installation spaces are required because four electric motors are required.

The invention has been made in view of the circumstances described above and aims to provide an electric vehicle that requires small spaces for the placement of components of a drive system, such as an electric motor, installed on a chassis while ensuring turning performance.

### Solution to Problem

In order to solve the aforementioned problems, first technical means of the invention include: a chassis; a pair of front and rear wheels provided on a right side of the chassis and a pair of front and rear wheels provided on a left side of the chassis; two electric motors that drive any of the right and left front wheels or the right and left rear wheels; a power transmission member that transmits power between the front and rear wheels of each pair; and a battery that supplies power to the electric motors.

According to second technical means, for driving the right and left front wheels, the two motors are arranged on right and left sides of the chassis at a front wheel end of the chassis, and for driving the right and left rear wheels, the two motors are arranged on right and left sides of the chassis at a rear wheel side of the chassis in the first technical means.

According to third technical means, the electric motors and the battery are stored in a bottom face part of the chassis in the second technical means.

According to fourth technical means, each of the pairs of front and rear wheels provided on right and left sides of the chassis is axially supported on an outer side of the chassis by an axle protruding from the chassis in any one of the first to third technical means.

According to fifth technical means, the power transmission member is provided outside the chassis in the fourth technical means.

According to sixth technical means, a gearbox is provided between each of the electric motors and the front wheel or the rear wheel driven by the electric motor in any one of the first to fifth technical means.

According to seventh technical means, a clutch that enables transmission or disengagement of power is provided in the gearbox in the sixth technical means.

According to eighth technical means, the front and rear wheels of each of the pairs of front and rear wheels provided on right and left sides of the chassis are formed with the same diameter, and the front wheel and the rear wheel of each of the pairs of front and rear wheels provided on right and left sides of the chassis are arranged in close contact with each other in any one of the first to seventh technical means.

### Advantageous Effects of Invention

According to the invention, in an electric vehicle including four wheels, a pair of front and rear wheels on a right side and a pair of front and rear wheels on a left side are each driven by a respective common electric motor, and thus the electric vehicle is able to change a forward direction by a difference in rotation between right and left drive wheels and turn with a center part of a chassis as a center by causing the right and left drive wheels opposite each other to rotate in different directions. The two motors that drive the respective front and rear wheels on the right side and the respective front and rear wheels on the left side are provided at a front wheel end or a rear wheel end, so that a space where components of a drive system, such as electric motors, are placed may be reduced, which enables a larger battery to be mounted.

### BRIEF DESCRIPTION OF DRAWINGS

FIG. 1 is a perspective view illustrating an example of an electric vehicle according to the invention.

FIG. 2 is a view for explaining an electric vehicle according to a first embodiment of the invention.

FIG. 3 is a view for explaining an electric vehicle according to a second embodiment of the invention.

FIG. 4 is a view for explaining an electric vehicle according to a third embodiment of the invention.

### DESCRIPTION OF EMBODIMENTS

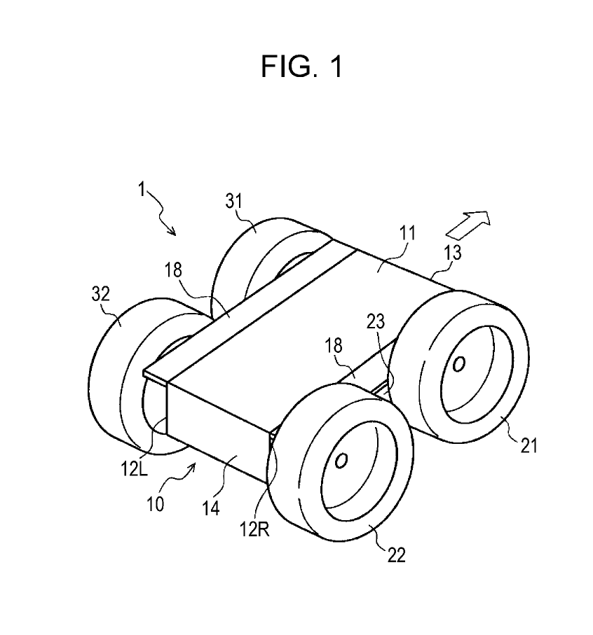

Hereinafter, descriptions will be given in detail for embodiments of the invention with reference to the drawings. In the descriptions below, like reference signs refer to like components in the respective drawings and descriptions thereof are omitted in some cases. FIG. 1 is a perspective view illustrating an example of an electric vehicle according to the invention, and an electric vehicle 1 is able to function as, for example, a mobile unit of a robot on which a camera or the like is mounted. The electric vehicle 1 incorporates, for example, a controller (not illustrated), and the controller controls, on the basis of an external signal or a detection result of the camera, a rotational speed, a rotation direction of an electric motor described below, and a braking amount and braking timing of front and rear wheels.

The electric vehicle 1 has a chassis 10, for example, formed in a rectangular shape, and has a front face 13 facing a forward direction indicated with an arrow and a rear face 14 and a right side face 12R and a left side face 12L that are opposed to a direction crossing the forward direction. The electric vehicle has four wheels consisting of a front wheel 21 and a rear wheel 22 on a right side, each of which is at a position protruding from the right side face 12R, and a front wheel 31 and a rear wheel 32 on a left side, each of which is at a position protruding from the left side face 12L.

Note that, a length (also referred to as an overall length of the chassis) of each of the right side face 12R and the left side face 12L is, for example, about 1 m, and a length (also referred to as a width of the chassis) of each of the front face 13 and the rear face 14 is, for example, about 0.8 to 0.9 m. Moreover, the distance between axles (also referred to as the wheel base) of the front wheel 21 and the rear wheel 22 on the right side or the front wheel 31 and the rear wheel 32 on the left side is set to be short, for example, about 0.8 m, and the electric vehicle 1 has mobility so as to be allowable to turn even in a narrow space. Note that, the outer diameters of the front wheels 21 and 31 and the rear wheels 22 and 32 illustrated in FIG. 1 are all the same at about φ0.4 m, for example.

### First Embodiment

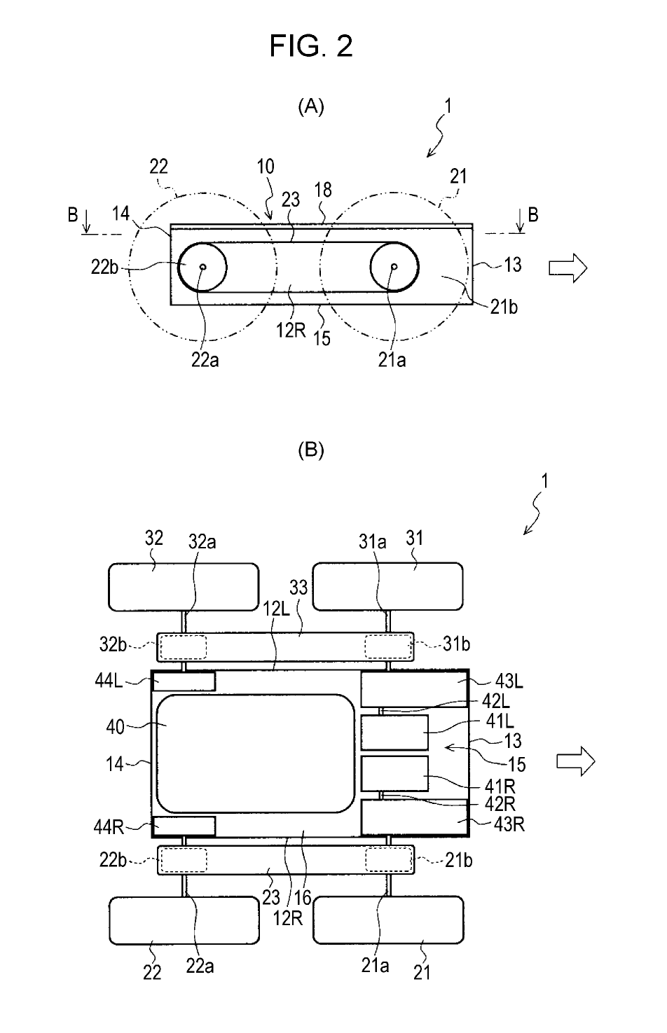

FIG. 2 is a view for explaining an electric vehicle according to a first embodiment of the invention. FIG. 2(A) illustrates a right side view in which the front wheel 21 and the rear wheel 22 on the right side are indicated by imaginary lines. FIG. 2(B) is a cross-sectional view taken along line B-B in FIG. 2(A), in which sprockets 21b, 22b, 31b, and 32b described below are indicated by imaginary lines. A cover 18 in a belt shape is provided on each of the side faces 12R and 12L of the chassis 10 and extends in a front-back direction of the chassis 10. Axles 21a and 31a and axles 22a and 32a that rotatably support the front wheels 21 and 31 and the rear wheels 22 and 32, are respectively provided underneath the respective covers 18. When not connected by a power transmission member, the axles 21a, 31a, 22a, and 32a are independently rotatable.

A power transmission member is provided in each of a pair of right-side front and rear wheels and a pair of left-side front and rear wheels. Specifically, the sprocket 21b and the sprocket 22b are respectively provided for the axle 21a of the front wheel 21 and the axle 22a of the rear wheel 22 on the right side, and a belt 23 on an inner side of which are provided protrusions that mesh with the sprockets, for example, is looped around the sprocket 21b for the front wheel and the sprocket 22b for the rear wheel. Similarly, the sprocket 31b and the sprocket 32b are respectively provided for the axle 31a of the front wheel 31 and the axle 32a of the rear wheel 32 on the left side, and a belt 33 similar to the belt 23 is looped around the sprocket 31b for the front wheel and the sprocket 32b for the rear wheel.

Thus, when each of the pair of right-side front and rear wheels and the pair of left-side front and rear wheels has one wheel used as a drive wheel, the other wheel functions as a driven wheel that is driven without slipping by causing the belt to serve as the power transmission member. As the power transmission member connecting the pair of right-side front and rear wheels or the pair of left-side front and rear wheels, in addition to the sprockets and the belt having the protrusions meshing with the sprockets, for example, the sprockets and a chain meshing with the sprockets may be used. Further, a pulley and a belt that have a great friction therebetween may be used as the power transmission member in a case where slip is allowable. However, the power transmission member needs to be configured such that a drive wheel and a driven wheel have the same rotational speed.

Note that, in the present embodiment, the sprockets 21b and 22b and the belt 23 on the right side which serves as the power transmission member are arranged outside the right side face 12R and underneath the cover 18, and the sprockets 31b and 32b and the belt 33 on the left side are arranged outside the left side face 12L and underneath the cover 18, but each of the power transmission members may be arranged inside the chassis 10 with the cover 18 omitted.

Two motors, consisting of an electric motor 41R for driving the right-side front and rear wheels 21 and 22 and an electric motor 42L for driving the left-side front and rear wheels 31 and 32, are provided on the front wheel side of a bottom face 15 of the chassis 10. A gearbox 43R is provided as a drive force transmission mechanism between a motor axis 42R of the right-side electric motor 41R and the axle 21a of the right-side front wheel 21. Similarly, a gearbox 43L is provided as a drive force transmission mechanism between a motor axis 42L of the left-side electric motor 41L and the axle 31a of the left-side front wheel 31. In the present embodiment, the two electric motors 41R and 41L are arranged in parallel so as to be symmetrical relative to a center line of the forward direction of the chassis, and the gearboxes 43R and 43L are respectively disposed on the right and left outer sides of the electric motors 41R and 41L.

Each of the gearboxes 43R and 43L is constituted by a plurality of gears, an axle, and the like, and is an assembly that transmits, to an axle serving as an output axis, power from the electric motor by changing torque, the rotational speed, or a rotation direction, and may include a clutch that switches transmission and disengagement of the power. Note that, the right and left rear wheels 22 and 32 are axially supported by bearings 44R and 44L, respectively, and the bearings 44R and 44L are respectively arranged to be in close contact with the right side face 12R and the left side face 12L of the bottom face 15 of the chassis 10.

In the present embodiment, with the configuration described above, the pair of front and rear wheels 21 and 22 on the right side and the pair of front and rear wheels 31 and 32 on the left side in the forward direction are able to be driven independently. That is, the power of the right-side electric motor 41R is transmitted to the gearbox 43R via the motor axis 42R and transmitted to the axle 21a with the rotational speed, torque, or rotation direction changed by the gearbox 43R. Then, the wheel 21 rotates with the rotation of the axle 21a, the rotation of the axle 21a is transmitted to the rear axis 22a via the sprocket 21b, the belt 23, and the sprocket 22b, and the rear wheel 22 rotates. The power of the left-side electric motor 41L is transmitted to the front wheel 31 and the rear wheel 32 in a similar manner to that of the right side as described above, and descriptions thereof will be omitted.

In the present embodiment, since a drive system of the electric vehicle 1 is configured such that the right and left sides relative to the center line of the forward direction have the same configuration, a well-balanced vehicle is achieved. Since the electric vehicle 1 is a four-wheel drive vehicle in which the drive force of the electric motors 41R and 41L is transmitted to all wheels, there is no trouble even in the case of travelling on a rough road of rough terrain or the like. Note that, in the first embodiment, the front wheels 21 and 31 correspond to the drive wheels, and the rear wheels 22 and 32 correspond to the driven wheels.

In a case where the two electric motors 41R and 41L have the same rotational speed, when the gearboxes 43R and 43L are set to have the same gear ratio (reduction ratio), the electric vehicle 1 moves forward or backward. Changing the speed of the electric vehicle 1 requires only the gear ratios of the gearboxes 43R and 43L to be changed to the same value. The forward direction is able to be changed by changing the gear ratios of the gearboxes 43R and 43L so as to cause a difference in rotational speed between the front wheel 21 and the rear wheel 22 on the right side and between the front wheel 31 and the rear wheel 32 on the left side. Further, by changing the rotation directions of outputs from the gearboxes 43R and 43L to make the rotation directions opposite to each other between the right-side wheels and the left-side wheels, it is possible to turn around on the spot with a center part of the chassis as a rotational axis.

Since a steering mechanism by which angles of the front and rear wheels are variable is not provided, when the electric vehicle 1 is caused to turn around on the spot, high resistance is applied to the wheels because the interval (wheel base) between the front and rear wheels is wide, and consequently, turning requires high drive torque. In the present embodiment, however, since the gear ratios of the gearboxes 43R and 43L are variable, high torque is able to be provided to the wheels by reducing only the rotational speed of the wheels at the time of the turning.

For example, as the gear ratio of the gearbox 43R, when the number of teeth of a gear on the motor axis 42R side is 10, the number of teeth of an intermediate gear is 20, and the number of teeth of a gear on the axle 21a side is 40, the rotational speed of the axle 21a is one-quarter the rotational speed of the motor axis 42R, but the torque thereof is four times that of the motor axis 42R. Since high torque may be obtained by selecting a gear ratio that further reduces the rotational speed, the turning is allowed even on a road surface such as rough terrain or a sand area where great resistance is applied to the wheels.

In the present embodiment, since the gearboxes 43R and 43L are respectively provided between the motor axis 42R and the axle 21a and between the motor axis 42L and the axle 31a, vibration from the wheels 21 and 31 is not directly transmitted to the motor axes. It is desired that a clutch that transmits or disengages (shuts off) the power be provided in each of the gearboxes 43R and 43L, and when the electric motors 41R and 41L are in a non-energized state, that the power transmission between the respective electric motors 41R and 41L and the respective axles 21a and 31a serving as the drive axes be disengaged. As a result, even when a force is applied to the chassis 10 when stopped and the wheels rotate, the rotation is not transmitted to the electric motors 41R and 41L, and as a result, a counter-electromotive force is not generated in the electric motors 41R and 41L and there is no possibility of damaging the circuits of the electric motors 41R and 41L.

In this manner, in the present embodiment, the respective pairs of right-side front and rear wheels and left-side front and rear wheels are connected by the respective power transmission members, and the four wheels are driven such that the two electric motors arranged on the front wheel side enable driving, and hence neither a dedicated electric motor for the rear wheels nor a dedicated gearbox for the rear wheels, which is required between the electric motor and each of the rear wheels, needs to be provided, thus making it possible to reduce the space where the electric motor and the dedicated gearbox for the rear wheels are placed. As described above, on the side of the front wheels 21 and 31 in the bottom face 15 of the chassis 10, the two electric motors 41R and 41L are arranged on the right and left sides in the forward direction, and the gearboxes 43R and 43L are respectively arranged on the right and left sides of the electric motors 41R and 41L. On the other hand, the bearings 44R and 44L are only arranged on the side of the rear wheels 22 and 32 in the bottom face 15 to ensure a large storage space 16 in the bottom face 15 of the chassis 10 extending from a center position thereof, for example, to an end of the rear face 14.

The electric motors 41R and 41L use a battery 40 as a power source and the battery 40 is able to be installed in the storage space 16. The battery 40 serves as a component that supplies power to each functional element of the electric vehicle 1 and as a component that supplies power for carrying out primarily a travel function, a distance detection function, a road surface judgment function, and a communication function. Regarding the type of the battery 40, for example, a lithium-ion battery, a nickel-hydrogen battery, a Ni—Cd battery, a lead-acid battery, a fuel battery, or a metal-air battery is used. More specifically, the battery 40 has an external shape of, for example, a rectangular solid and is able to be placed at a substantially center position of the bottom face 15 as illustrated in FIG. 2(B). It is desired that the rear face 14 of the chassis 10 be configured to be openable and closable, for example, with respect to the top face 11 or the bottom face 15 so that the battery 40 may be easily placed and removed from the storage space 16. Thereby, a large-capacity battery 40 for realizing traveling for long periods is able to be placed in the storage space 16 of the chassis 10, and replacement, charging, inspection or the like of the battery 40 may be easily carried out from the rear face 14. Further, since the battery 40 is able to be disposed on the bottom face 15, it is possible to obtain an electric vehicle with a low center of gravity of the chassis 10 that is able to travel stably. Since electric motors that generate great amount of heat are arranged on the front side in the forward direction in the first embodiment, air cooling is able to be easily performed.

### Second Embodiment

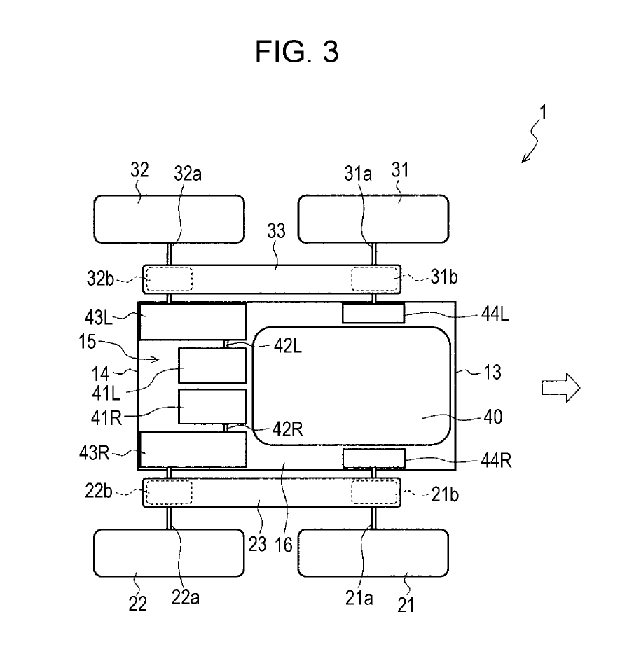

FIG. 3 is a view for explaining an electric vehicle according to a second embodiment of the invention, and illustrates a cross-sectional view similarly to FIG. 2(B). While the front wheels 21 and 31 serve as the drive wheels and the rear wheels 22 and 32 serve as the driven wheels in the first embodiment, the rear wheels 22 and 32 serve as the drive wheels and the front wheels 21 and 31 serve as the driven wheels in the second embodiment. Thus, the electric motors 41R and 41L and the gearboxes 43R and 43L are arranged on the side of the rear wheels 22 and 32 in the chassis 10. The axles 21a and 31a of the front wheels 21 and 31 are axially supported by the bearings 44R and 44L, respectively.

The power of the electric motor 41R on the right side is transmitted to the gearbox 43R via the motor axis 42R, and transmitted to the axle 22a with the rotational speed, torque, or rotation direction changed by the gearbox 43R. Then, the rear wheel 22 rotates with the rotation of the axle 22a, and the rotation of the axle 22a is transmitted to the axle 21a via the sprocket 22b, the belt 23, and the sprocket 21b, and the front wheel 21 rotates. The power of the electric motor 41L on the left side is transmitted to the rear wheel 32 and the front wheel 31 in a similar manner to that of the right side. In the second embodiment, on the bottom face 15 of the chassis 10, the storage space 16 is secured over a wide range from a center position thereof, for example, to an end of the front face 13, and hence the battery 40 is able to be placed in the storage space. Note that, in this case, the front face 13 is configured to be openable and closable, for example, with respect to the top face 11 or the bottom face 15.

### Third Embodiment

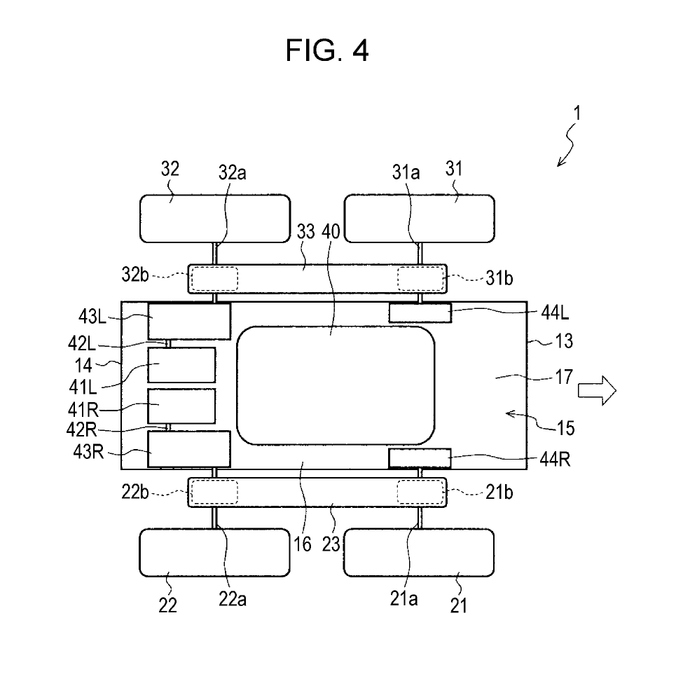

FIG. 4 is a view for explaining an electric vehicle according to a third embodiment of the invention and illustrates a cross-sectional view similarly to FIG. 2(B). In the third embodiment, a drive mechanism of wheels is arranged in the same manner as that of the second embodiment, but, compared with the second embodiment, the storage space 16 is provided in a much wider range from a center position of the bottom face 15, for example, to the front face 13. Thus, a large capacity battery 40 is able to be placed at the center position of the bottom face 15 and stability of the chassis 10 may be improved. Additionally, in the third embodiment, a slide permitted area 17 where the battery 40 is permitted to slide on the bottom face 15 is further provided, and as a result, working of replacement, charging, or the like of the battery may be easily carried out, for example.

### Fourth Embodiment

In the first to third embodiments, the power from the electric motors 41R and 41L is transmitted to the axles of the drive wheels via the gearboxes 43R and 43L, and torque, the rotational speed, or rotation direction is changed by the gearboxes 43R and 43L for the power from the electric motors 41R and 41L, and accelerating or decelerating, changing of the direction, or turning of the electric vehicle 1 may be performed. On the other hand, in a fourth embodiment, the power from the electric motors 41R and 41L is transmitted to the axles of the drive wheels simply via only a gear with a fixed ratio (predetermined constant ratio), and by changing magnitude of a drive voltage or a frequency for the electric motors, rotation directions and speeds of right and left drive axes are changed. As a result, a gearbox (transmission) that is a complex machine mechanism does not need to be provided and only the gear is used, so that a mechanical failure and burden of maintenance are reduced and weight reduction in the electric vehicle may be achieved because the gearbox is not required.

### Fifth Embodiment

In the first to third embodiments, each pair of front and rear wheels is configured to be connected by the sprockets and the belt and the power from the electric motors is transmitted to the front and rear wheels. However, an electromagnetic clutch, for example, as a power transmission member may be provided at each of portions where the wheels (the front wheels 21 and 31 and the rear wheels 22 and 32) and the axles 21a, 31a, 22a, and 32a are respectively connected such that only the front wheels 21 and 31 or only the rear wheels 22 and 32 are driven, or further only one wheel is driven. In this case, it is possible to control rotation of the four wheels independently, and when transmission and disengagement of the power are switched at high speed by using the electromagnetic clutch, it is possible to keep a stable travel direction by controlling rotation of each of the wheels even in a case where a friction coefficient is low with respect to a road surface such as an icy or muddy road. By holding a rotating disc provided in the electromagnetic clutch with the use of a fixing member, usage as a brake is also possible.

### REFERENCE SIGNS LIST

1 electric vehicle
10 chassis
11 top face
12R right side face
12L left side face
13 front face
14 rear face
15 bottom face
16 storage space
17 slide permitted area
18 cover
21, 31 front wheel
22, 32 rear wheel
21a, 22a, 31a, 32a axle
21b, 22b, 31b, 32b sprocket
23, 33 belt
40 battery
41R, 41L electric motor
42R, 42L motor axis
43R, 43L gearbox
44R, 44L bearing

1. An electric vehicle, comprising:
a chassis;
a pair of front and rear wheels provided on a right side of the chassis and a pair of front and rear wheels provided on a left side of the chassis;
two electric motors that drive any of the right and left front wheels or the right and left rear wheels;
a power transmission member that transmits power between the front and rear wheels of each pair; and
a battery that supplies power to the electric motors.

2. The electric vehicle according to claim 1, wherein for driving the right and left front wheels, the two electric motors are arranged on right and left sides of the chassis at a front wheel end of the chassis, and for driving the right and left rear wheels, the two motors are arranged on right and left sides of the chassis at a rear wheel side of the chassis.

3. The electric vehicle according to claim 1, wherein the electric motors and the battery are stored in a bottom face part of the chassis.

4. The electric vehicle according to claim 1, wherein each of the pairs of front and rear wheels provided on right and left sides of the chassis is axially supported on an outer side of the chassis by an axle protruding from the chassis.

5. The electric vehicle according to claim 4, wherein the power transmission member is provided outside the chassis.

6. The electric vehicle according to claim 1, wherein a gearbox is provided between each of the electric motors and the front wheel or the rear wheel driven by the electric motor.

7. The electric vehicle according to claim 6, wherein a clutch that enables transmission or disengagement of power is provided in the gearbox.

8. The electric vehicle according to claim 1, wherein the front and rear wheels of each of the pairs of front and rear wheels provided on right and left sides of the chassis are formed with the same diameter, and the front wheel and the rear wheel of each of the pairs of front and rear wheels provided on right and left sides of the chassis are arranged in close contact with each other.

9. The electric vehicle according to claim 2, wherein each of the pairs of front and rear wheels provided on right and left sides of the chassis is axially supported on an outer side of the chassis by an axle protruding from the chassis.

10. The electric vehicle according to claim 9, wherein the power transmission member is provided outside the chassis.

11. The electric vehicle according to claim 3, wherein each of the pairs of front and rear wheels provided on right and left sides of the chassis is axially supported on an outer side of the chassis by an axle protruding from the chassis.

12. The electric vehicle according to claim 11, wherein the power transmission member is provided outside the chassis.

13. The electric vehicle according to claim 2, wherein the electric motors and the battery are stored in a bottom face part of the chassis.

14. The electric vehicle according to claim 13, wherein each of the pairs of front and rear wheels provided on right and left sides of the chassis is axially supported on an outer side of the chassis by an axle protruding from the chassis.

15. The electric vehicle according to claim 14, wherein the power transmission member is provided outside the chassis.
